(19) United States
(12) Patent Application Publication
(10) Pub. No.: US 2025/0009484 A1
(43) Pub. Date: Jan. 9, 2025

(54) COMPUTER-IMPLEMENTED METHOD FOR AUTOMATICALLY TRANSLATING A CUTTING LINE FOR AN ORTHODONTIC APPLIANCE

(71) Applicant: Hirsch Dynamics Holding AG, Wollerau (CH)

(72) Inventor: Markus HIRSCH, Wollerau (CH)

(73) Assignee: Hirsch Dynamics Holding AG, Wollerau (CH)

(21) Appl. No.: 18/890,899

(22) Filed: Sep. 20, 2024

Related U.S. Application Data
(63) Continuation of application No. PCT/EP2022/058243, filed on Mar. 29, 2022.

(51) Int. Cl. A61C 13/00; A61C 7/08

(52) U.S. Cl. CPC A61C 13/0004; A61C 7/08; A61C 13/0018

(57) ABSTRACT

A computer-implemented method automatically translates at least one pre-defined digital data record representing a cutting line for an orthodontic appliance, preferably in the form of an aligner, a retainer or a bracket, into at least one translated digital data record readable by at least one manufacturing facility, preferably including a milling device and/or a laser device. An algorithm automatically transfers the at least one pre-defined digital data record into at least one translated digital data record representing at least one translated cutting line such that the at least one manufacturing facility can directly cut the orthodontic appliance along the translated cutting line.

### CROSS REFERENCE TO RELATED APPLICATIONS

This application is a continuation of and Applicant claims priority under 35 U.S.C. § 120 of International Application No. PCT/EP2022/058243 filed on Mar. 29, 2022, The international application under PCT article 21(2) was published in English. The disclosure of the aforesaid International Application is hereby incorporated by reference.

### BACKGROUND OF THE INVENTION

### 1. Field of the Invention

The present invention relates to a computer-implemented method for automatically translating at least one pre-defined digital data record representing a cutting line for an orthodontic appliance, preferred in the form of an aligner, a retainer or a bracket, into at least one translated digital data record. Furthermore, the present invention relates to a computer program, a system for creating a translated cutting line for an orthodontic appliance as well as a method for manufacturing an orthodontic appliance.

### 2. Description of the Related Art

Such a method is shown in prior art document WO 2018/080829 A1, whereby the traditional way of cutting the orthodontic appliance manually is improved by means of including markers in a cutting line by use of a CAD and CAM system as a guideline for the staff that has to cut the orthodontic appliance. It is possible that the staff uses computer-controlled milling devices or laser devise to cut the orthodontic appliance. The milling device or laser device can for example comprise a camera by means the markers of the cutting line is identified and used to rearrange the device for the cutting procedure.

A disadvantage of the prior art is that the method is limited to a specific cutting device, whereby for the case that a different cutting tool is used or the manufacturing of the orthodontic appliance is intended to be performed on a different manufacturing facility, cumbersome manual adaptions are required to achieve identical qualities of the orthodontic appliance. Moreover, the preparation of files by means of the CAD or Cam system is tedious, if a certain quality of the cutting line has to be assured for a comfortable fit. Furthermore, additional components like a camera to record the markers as well as additional production steps to incorporate the markers in the orthodontic appliance are required, whereby the markers affect a visual appearance of the orthodontic appliance if they are not completely removed during the manufacturing process.

Moreover, it is a long-standing need to eliminate the missing link between the CAD/CAM software or a treatment planning software as a construction facility and the specific circumstances of a variety of manufacturing facilities, whereby manual adaptions are time expensive and requires personal staff that is trained with respect to the CAD/CAM software or the treatment planning software as well as to the specific cutting devices.

### SUMMARY OF THE INVENTION

It is an object of the present invention to simplify and accelerate the cutting of orthodontic appliances by a system and methods that are appropriate to eliminate at least some of the disadvantages of the prior art, whereby in particular a series production of orthodontic appliances is automatically facilitated without manually amending the cutting lines of a CAD/CAM or treatment planning software on basis of a specific cutting tool of a manufacturing facility.

The object of the present invention is accomplished by a method for automatically translating at least one pre-defined digital data record representing a cutting line for an orthodontic appliance, which is preferably in the form of an aligner, a retainer or a bracket, into at least one translated digital data record.

The at least one translated digital data record is readable by at least one manufacturing facility, preferably comprising a milling device and/or a laser device, whereby an algorithm automatically transfers the at least one pre-defined digital data record into at least one translated digital data record representing at least one translated cutting line such that the at least one manufacturing facility can directly cut the orthodontic appliance along the translated cutting line.

This enables an efficient and a flexible way to directly cut the orthodontic appliance on basis of a cutting line provided by a construction facility that is not in conformity with a specific cutting device of a manufacturing facility. Hence, without the adaption of the algorithm the orthodontic appliance would be cut improperly for a suitable fit at a patient's dentition since the geometry of the specific milling tool for example is not included in the pre-defined digital data record. In addition, the series-production can be assured without the need of a high number of trained staff or adaptions for specific cutting devices.

Moreover, cutting devices require in general a specific digital data record with velocities for the cutting tool readable by the cutting device which can be incorporated in the translated digital data record—by means of a configuration file for instance.

Furthermore, the algorithm is flexibly adaptable to new manufacturing facilities and/or to new formats of the pre-defined digital data records, whereby a manual amendment of each cutting line for a specific manufacturing facility or a different cutting device is not necessary.

A cutting device to cut the orthodontic appliance is in general arbitrary and can be in general in the form of a trimming device apart from a milling tool or a laser like an ultra-sound trimming tool, a water jet cutter or a soldering iron. The cutting device comprises particularly preferred a five-axes milling device or a six-axes cutting device to cut the orthodontic appliance (preferably in the form of an aligner). In general, the cutting device can be used in a way that a mold for manufacturing the orthodontic appliance can be reused.

Not only is the pre-defined digital data record transferred into a form that is readable by a specific cutting machine, but also the cutting line is mapped to a translated cutting line containing adaptions with respect to a specific cutting device.

As stated above, the invention also relates to a computer program which, when the program is executed by a computer causes the computer to carry out the computer-implemented method.

The computer program can be stored on a, preferably non-volatile, data carrier and/or transmitted via a data carrier signal.

As stated above, the invention also relates to a system for creating a translated cutting line for an orthodontic appliance, which is preferably in the form of an aligner, a retainer or a bracket, comprising at least one computing device, at least one memory device which can be accessed by the at least one computing device, at least one first interface for receiving at least one pre-defined digital data record representing a cutting line for the orthodontic appliance and/or for storing at least one pre-defined digital data record and/or at least one translated digital data record representing the translated cutting line for the orthodontic appliance in the at least one memory device and at least one second interface for outputting the at least one translated digital data record, whereby the at least one computing device is configured to transfers the at least one pre-defined digital data record into the at least one translated digital data record such that at least one manufacturing facility can read the at least one translated digital data record and directly cut the orthodontic appliance along the translated cutting line.

The system can be situated at a construction facility which constructs cutting lines or gathers pre-defined digital data records and/or at a manufacturing facility to which pre-defined digital data records are sent. In general, the system can constitute an intermediate entity like a cloud, a server, a computer or the like which collects pre-defined digital data records of a construction facility and transmits translated digital data records to a manufacturing facility.

As stated above, the invention further relates to a method for manufacturing an orthodontic appliance, which is preferably in the form of an aligner, a retainer or a bracket, whereby the following steps are performed:
inputting of at least one a pre-defined digital data record representing a cutting line for the orthodontic appliance
transferring the at least one pre-defined digital data record into at least one translated digital data record representing a translated cutting line for the orthodontic appliance readable by at least one manufacturing facility
manufacturing the orthodontic appliance
cutting the orthodontic appliance by means of the manufacturing facility, preferred milling device and/or laser device, along the translated cutting line
if applicable, iterating the process step of manufacturing and cutting for a plurality of treatment steps based on a plurality of translated digital data records.

The transfer of the at least one pre-defined digital data record is particularly implemented by means of the algorithm of the computer-implemented method. Final grinding process steps are possible but not necessarily required.

Preferred embodiments of the present invention are defined in the dependent claims. Features of the method claims are applicable with respect to the product claims and vice versa. Features of a specific method claim are applicable with respect to other method claims as well.

It is particularly preferred provided that the at least one pre-defined digital data record and/or the at least one translated digital data record comprises a discrete set of, preferred spatially and/or equidistantly, separated points along the cutting line and/or the translated cutting line, whereby it is preferred that the at least one pre-defined digital data record and/or the at least one translated digital data record is in the form of a CSV file and/or a TXT file and/or an STL file and/or a CAD file and/or the at least one translated digital data record represents a closed spline around the orthodontic appliance to be cut.

For example, the algorithm determines within a pre-defined digital data record a direction in which the points are referenced for a cutting direction and a starting point for cutting like the last molar on the left side of the dentition—indicated for example by the highest vertical coordinate in connection with a positive lateral coordinate. Afterwards, the algorithm can calculate corrected points for the translated cutting line including the geometry of the cutting device, a desired cutting depth or a defined distance point for the cutting start.

In general, information like boundary conditions and/or machine specific parameters can be gathered from a configuration file and/or vector calculus is applied by the algorithm. In general, the translated digital data record is provided in machine language in order to be directly used by the cutting device to cut the orthodontic appliance properly.

In a preferred embodiment of the present invention, it is provided that the at least one pre-defined digital data record
is constructed manually or automatically by means of a CAD software, a CAM software and/or a treatment planning software and/or
comprises six coordinates for each point of the cutting line, whereby three coordinates correspond to each point and three coordinates correspond to a normal vector and/or a unit vector for each point.

The manual construction at a construction facility can be for example done in a lab by a dentist or by a staff based on a three-dimensional virtual model of a patient's dentition without knowing the specific characteristics of the cutting device that will afterwards cut the orthodontic appliance to the desired form. By the coordinates, the cutting line is represented in the pre-defined digital data record—in general prior to transmission to the manufacturing facility.

It is particularly preferred provided that the at least one translated digital data record comprises three coordinates and at least two angles for each point of the translated cutting line for a cutting device of the at least one manufacturing facility.

Hence, the cutting tool can be arranged with respect to the orthodontic appliance to cut the orthodontic appliance and without colliding with parts of a mold, the cutting device or the orthodontic appliance.

It is particularly preferred provided that the at least one translated digital data record is created for a specific cutting device, preferred milling tool and/or laser, of the at least one manufacturing facility.

Properties of the specific milling tool for instance can be gathered in a configuration file in order to adapt the cutting line to the translated cutting line readable by the manufacturing facility for direct cutting of the orthodontic appliance.

In a preferred embodiment of the present invention, it is provided that the at least one translated digital data record comprises, preferably for each point and/or between two adjacent points along the translated cutting line, a translation and/or a rotation of the coordinates of the at least one pre-defined digital data record.

This enables a correction of the cutting line according to specific geometries of a trimming tool or boundary conditions of the cutting device.

It is particularly preferably provided that at least one configuration file is created and/or used to create the at least one translated digital data record for a specific cutting device, preferred milling tool and or laser, of the at least one manufacturing facility, whereby the at least one configuration file comprises at least one of the following parameters of and/or for the at least one manufacturing facility, preferably for each point and/or between two adjacent points along the translated cutting line: a velocity for the cutting device, a penetration depth for the cutting device, a half of an lateral extension of the cutting device, a length of the cutting device, a longitudinal extension of the milling tool, a laser intensity, a smoothening degree, a number of iteration steps, a minimal declination angle to a basic level.

Other parameters of interest of the manufacturing facility are inter alia the following: basic level height, distance point for cutting start, number of points ahead to create a progression vector, miller diameter, spindle speed, feed rate from basic level, feed rate from safety point to cutting start, feed rate for cutting, minimum gap between cutting line and translated cutting line and others. Thus, the arrangement of the orthodontic appliance and the position of the cutting device with respect to the orthodontic appliance during cutting can be incorporated in the translated digital data record.

In a preferred embodiment of the present invention, it is provided that the algorithm accesses the configuration file and the at least one pre-defined digital data record, and preferably all pre-defined digital data records within a specific folder, for creation of the at least one translated digital data record, and preferably all of a plurality of translated digital data records.

This makes it possible to automatically create a plurality of translated digital data records in a single instruction within the algorithm without requiring to address each pre-defined digital data record specifically. For example, the algorithm can search for specific file extensions and/or specific prefixes within a dictionary of pre-defined digital data records and/or output translated digital data records with specific prefixes in order to automatically be read by the at least one manufacturing facility.

It is particularly preferably provided that the algorithm comprises an artificial intelligence, preferred comprising neuronal networks, machine learning and/or deep-learning, to create the at least one translated digital data record.

By means of the artificial intelligence, the translated digital data records can be improved over time, for example with respect to an inclusion of further file formats of pre-defined digital data records, different manufacturing facilities, distinct cutting devices et cetera or to improve cutting surfaces without the need of adapting the source code of the algorithm.

A structure of an artificial intelligence applicable for processing the cutting line and/or the at least one pre-defined digital data record and/or transferring the cutting line into the at least one translated digital data record can be comprehended for example by means of application number PCT/EP2020/087806, the disclosure of which is herein incorporated by reference.

In a preferred embodiment of the present invention, it is provided that the translated cutting line of the at least one translated digital data record is smoothened with respect to the cutting line of the at least one pre-defined digital data record, whereby it is preferred that the at least one translated digital data record comprises supplementary points along the translated cutting line.

This enables an improved cutting surface of the orthodontic appliance with respect to the previous cutting line presented in the pre-defined digital data record.

During smoothening, supplementary points can be added to create a fluent movement of the cutting device and/or a smooth cutting surface. The process of smoothening can be done iteratively and/or can comprise a certain number of points of the cutting line and/or translated cutting line to be considered for smoothening.

It is particularly preferred provided that the system comprises
a manufacturing facility, preferably in the form of a cutting device comprising a milling tool or a laser, for manufacturing the orthodontic appliance and/or
a construction facility in the form of a client, preferably in the form of a CAD client, a CAM client and/or a treatment planning software, for constructing a three-dimensional virtual model representing at least part of a dentition of a patient and/or the orthodontic appliance, whereby the client is configured to automatically construct the cutting line based on the three-dimensional virtual model and/or the translated cutting line based on the at least one pre-defined digital data record,

whereby it is preferred that the manufacturing facility and the construction facility are in signal-conducting data connection.

The system—in particular the computer-implemented method by means of the algorithm—can constitute the intersection between the manufacturing facility and the construction facility.

In a preferred embodiment of the present invention, it is provided that a mold is manufactured by means of a three-dimensional virtual model representing at least part of a dentition of a patient of a construction facility in the form of a client, preferred in the form of a CAD client, a CAM client and/or a treatment planning software, whereby the orthodontic appliance to be manufactured is in the form of an aligner which is formed over the mold.

The computer-implemented method can be easily embedded within the value chain and/or the production process from creation of the three-dimensional virtual model to the completion of the orthodontic appliance.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIGS. 1A and 1B show an orthodontic appliance in the form of an aligner, cut by means of a cutting device in a perspective view and in a top view during manufacturing; and

FIGS. 2A, 2B, and 2C show a schematic illustration of an orthodontic appliance in the form of an aligner with a cutting line in reference to a mold in a perspective view as well as a cutting line with a pre-defined digital data record and a section of a translated cutting line with a translated digital data record.

### DETAILED DESCRIPTION OF PREFERRED EMBODIMENTS

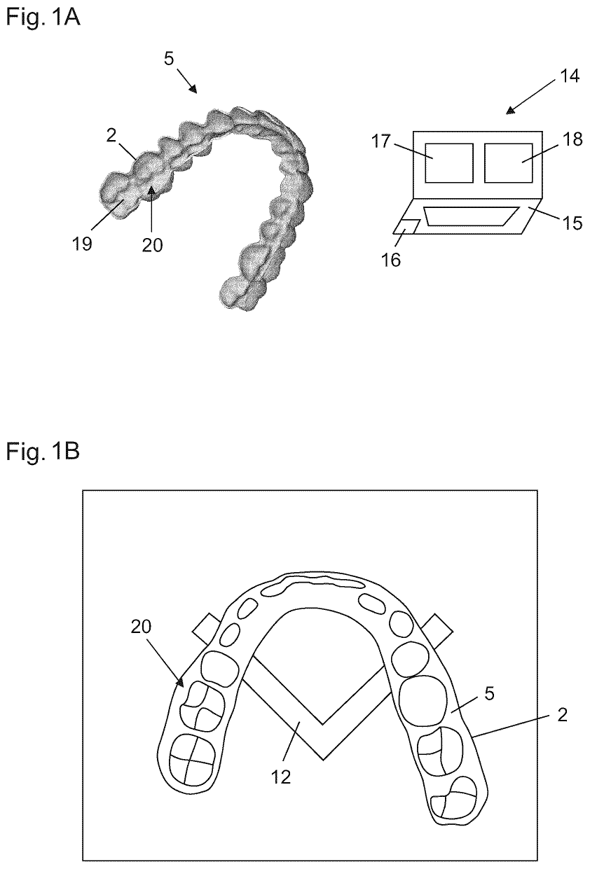

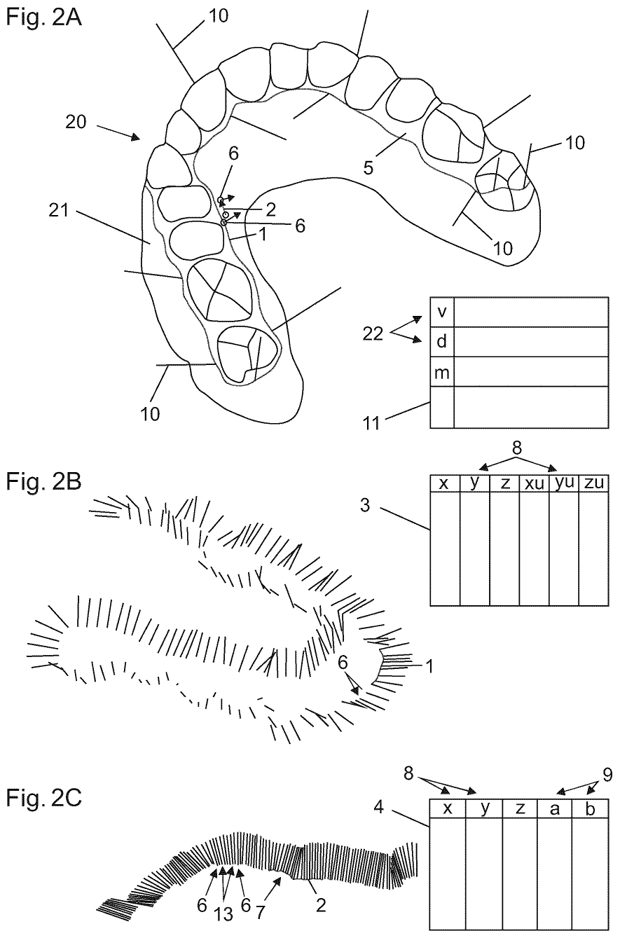

FIG. 1A discloses schematically a system for creating a translated cutting line 2 (cf. FIGS. 2A to 2C) for an orthodontic appliance 5 in the form of an aligner. The system is applicable for orthodontic appliances 5 like lingual or labial retainers or brackets as well.

The system comprises a computing device 15, a memory device 16 which can be accessed by the computing device 15, a first interface 17 for receiving pre-defined digital data records 3 representing a cutting line 1 for the orthodontic appliance 5 and for storing translated digital data records 4 representing the translated cutting line 2 for the orthodontic appliance 5 in the memory device 16 and a second interface 18 for outputting the translated digital data record 4.

The computing device 15 is configured to transfer a plurality of pre-defined digital data records 3 into a plurality of translated digital data records 4 such that one or a plurality of manufacturing facilities can read the translated digital data records 4 and directly cut the orthodontic appliance 5 along the translated cutting line 2.

The system comprises a manufacturing facility (not shown in the illustration) in the form of a cutting device 10 comprising a milling tool or a laser for manufacturing the orthodontic appliance 5 and a construction facility (illustrated by the computer 14) in the form of a client in the form of a CAD client, a CAM client or a treatment planning software for constructing a three-dimensional virtual model 19 representing a dentition 20 of a patient and the orthodontic appliance 5. The three-dimensional virtual model 19 is represented in this figure by means of the negative surface of the aligner. In general, the three-dimensional virtual model 19 represents the dentition 20 of the patient in order to construct the orthodontic appliance 5.

The client in the form of a software stored and processed by the computer 14 is configured to automatically construct the cutting line 1 based on the three-dimensional virtual model 19 and to construct the translated cutting line 2 based on the least one pre-defined digital data record 3, whereby in general the cutting line 1 and the cutting line 2 can be derived at spatially separated instances by sending the pre-defined digital data record 3 to the computer 14 (which can be in general a tablet, a smartphone, a control device or as the case may be).

The translated digital data records 4 can be sent to the manufacturing facility via a signal-conducting data connection with the construction facility like the internet, WiFi and/or LAN.

A computer program is stored on the computer 14 and executed by the computing device 15 of the computer 15 which causes the computer 14 to carry out a computer-implemented method to transfer the cutting line 1—in general constructed by the construction facility—into the translated cutting line 2 which can be used directly by the manufacturing facility.

FIG. 1B discloses the orthodontic appliance 5 to be cut by the translated cutting line 2 in an arrangement at the manufacturing facility. The orthodontic appliance 5 is situated—potentially indirect via a mold 21—onto a basic level 12 such that the translated cutting line 2 can be driven along by a cutting device 10 like a milling tool or a laser tool.

A method for manufacturing the orthodontic appliance 5 in the form of an aligner can be exemplified as follows: The pre-defined digital data record 3 representing the cutting line 1 for the orthodontic appliance 5 is inputted by the client—in general for each step of a treatment plan. The pre-defined digital data record 3 is transferred into the translated digital data record 4 representing the translated cutting line 2 for the orthodontic appliance 5 readable by the manufacturing facility with a specific cutting device 10. A mold 21 is manufactured by means of the three-dimensional virtual model 19 of a construction facility representing at least part of the dentition 20 of a patient via the client like a CAD client, a CAM client or a treatment planning software. The orthodontic appliance 5 is manufactured by forming a sheet of—particularly transparent or translucent—plastic over the mold 21. The orthodontic appliance 5 is manufactured by deep drawing by means of the mold 21. The orthodontic appliance 5 is cut by means of the cutting device 10 of the manufacturing facility along the translated cutting line 2. If a plurality of treatment steps is intended for the treatment of the patient's dentition 20, several process steps can be iteratively performed.

FIG. 2A discloses an orthodontic appliance 5 in the form of an aligner situated on a mold 21 in the form of a three-dimensional virtual model representing the mold 21 and the aligner. The cutting line 1 is indicated by a dotted line that is mapped in the pre-defined digital data record 3 (cf. FIG. 2B).

In order to facilitate the direct production of the orthodontic appliance 5, the cutting line 1 has to be transferred into the translated cutting line 2 (by means of the translated digital data record 4 in machine language) readably by the manufacturing facility comprising a specific geometry and boundary conditions of the cutting device 10 to produce the orthodontic appliance with a high quality and wearing comfort.

A computer-implemented method for automatically translating the pre-defined digital data record 3 representing the cutting line 1 for the orthodontic appliance 5 into the translated digital data record 4 readable by the manufacturing facility is used for this purpose, whereby an algorithm transfers the pre-defined digital data record 3 into the translated digital data record 4 representing the translated cutting line 2 such that the manufacturing facility can directly cut the orthodontic appliance 5 along the translated cutting line 2.

In this shown embodiment, a configuration file 11 for a specific cutting device 10 of the manufacturing facility comprising a milling tool with defined geometry and properties like velocity characteristics and mobility is created and used to create the translated digital data record 4. In general, a five-axes milling machine is used, whereby the cutting device 10 can also be provided in the form of a laser device.

The configuration file 11 comprises parameters 22 of and for the manufacturing facility like a velocity for the cutting device 10, a penetration depth for the cutting device 10, a half of an lateral extension of the cutting device 10, a length of the cutting device 10, a longitudinal extension of the milling tool, a smoothening degree, a number of iteration steps for smoothening the cutting line 1 or a minimal declination angle to the basic level 12.

The algorithm can access the configuration file 11 and a plurality of pre-defined digital data records 3 within a specific folder for creation of translated digital data records 4.

Along the cutting line 1 several positions and orientations of the cutting device 10 are indicated with an infinitely small milling head. Since the milling tool used in this embodiment to cut the orthodontic appliance 5 has a definite form, the cutting line 1 has to be shifted according to the geometry and boundary conditions of the cutting device 10, whereby the normal vector of a point 6 along the cutting line 1 (indicated by a circle) is converted into a unit vector and shifted to the translated cutting line 2 (indicated by a further circle) in order to take the cutting device 10 into account. The cutting line 2 is sequentially developed by progression vectors (indicated by an arrow between two circles).

The setup of manufacturing, the shape of the orthodontic appliance 5 as well as the measurements of the cutting device 10 can differ from a first manufacturing facility to a second manufacturing facility, whereby in addition different milling tools can be used as well. Hence, the configuration file 11 can be used for a specific cutting device 10 in order to facilitate a high amount of orthodontic appliance to be produced as well as a smooth cutting surface for the orthodontic appliance 5 for a comfortable fit for the patient without requiring further amendments to the pre-defined digital data records 3 or translated digital data records 4.

The orientation of the cutting surface can be adapted according to a desired orientation as well. Minimum angles 9 and variable velocities for the cutting device 10 to cut the orthodontic appliance 5 can be set for distinct points 6 or between distinct points 6 and included in the construction of the translated cutting line 2 for instance on basis of the configuration file 11.

In general, a wide variety of different pre-defined digital data records 3 can be used to construct the translated cutting line 2, whereby for instance normal vectors of the cutting line 1 can be transferred into unit vectors or boundary conditions regarding the manufacturing facility like a shape of a specific milling tool can be incorporated in the translated digital data record 4 via vector analysis automatically via the configuration file 11 for instance.

FIG. 2B discloses a cutting line 1 constructed by a CAD client or outputted by a treatment planning software. The cutting line 1 is mapped in the pre-defined digital data record 3 that has to be transferred into the translated digital data record 4—both can be in the form of a CSV file, a TXT file, an STL file, a CAD file or other file formats readable by the manufacturing facility.

The pre-defined digital data record 3 comprises a discrete set of spatially separated points 6 along the cutting line 1 that correspond to six coordinates 8 for each point 6 of the cutting line 1 in the pe-defined digital data record 3, whereby three coordinates 8 correspond to each point and three coordinates 8 correspond to a normal vector for each point 6.

The pre-defined digital data record 3 is constructed manually or automatically by means of a CAD software, a CAM software or a treatment planning software and is automatically transferred into the translated digital data record 4 by means of the algorithm of the computer-implemented method.

FIG. 2C discloses a translated cutting line 2 in connection with the corresponding translated digital data record 4, whereby the translated digital data record 4 represents a closed spline 7 around the orthodontic appliance 5 to be cut.

The translated digital data record 4 comprises a discrete set of spatially and equidistantly separated points 6 along the translated cutting line 2, whereby for each point 6 and between two adjacent points 6 along the translated cutting line 2 the specific cutting device 10 is considered in order to facilitate a direct reading and a direct cutting of the orthodontic appliance 5 without requiring a manual translation based on the pre-defined digital data record 3.

The translated digital data record 4 comprises three coordinates 8 and two angles 9 for each point 6 of the translated cutting line 2 for the cutting device 10 of the manufacturing facility, whereby geometry of the cutting device 10 and parameters like a velocity of the cutting device 10 can be incorporated in the translated digital data record 4.

The translated digital data record 4 is created for a specific cutting device 10 in the form of a milling tool or a laser.

The translated digital data record 4 comprises for each point 6 or between two adjacent points 6 along the translated cutting line 2 a translation and if applicable a rotation of the coordinates 8 of the pre-defined digital data record 3.

The translated cutting line 2 of the translated digital data record 4 is—in general iteratively—smoothened with respect to the cutting line 1 of the digital data record 3, whereby the translated digital data record 4 comprises supplementary points 13 along the translated cutting line 2.

The algorithm for transferring the cutting line 1 into the translated cutting line 2 comprises an artificial intelligence. The structure of the artificial intelligence is in general arbitrary, whereby for example neuronal networks, machine learning or deep-learning can be used within the artificial intelligence to create the translated digital data record 4.

To train the artificial intelligence, a multitude of pre-defined digital data records 3 can be inputted in the course of a learning session of the artificial intelligence in order to achieve the translated digital data record 4 with potentially supplementary points 13, a smoothened contour, amended coordinates 8 (potentially with corrected angles, unit vectors, shifts et cetera) or as the case may be. To improve the artificial intelligence, pre-defined digital data records 3 can be processed with different file extensions—for example on basis of different clients like a CAD client and a treatment planning software.

The coordinates 8 with respect to the cutting line 1 are shifted to the coordinates 8 with respect to the translated cutting line 2, whereby the translated digital data record 4 is configured to be read by the manufacturing facility—in particular by a laser device or a cutting device 10 comprising a milling tool. A shift can be necessary for example due to a defined geometry of a specific milling tool.

The coordinates 8 of the pre-defined digital data record 3 are transferred to at least two angles 9 for the cutting device 10 in the translated digital data record 4 to avoid a collision with the cutting device 10 with the mold 21 or a basic level 12 where the orthodontic appliance 5 or the mold 21 rests on during production for instance. A minimal declination angle 9 can be used for at least one angle 9, which can be stored in and accessed via the configuration file 11.

The digital data record 3 is configured to be read immediately by the cutting device 10 to cut the orthodontic appliance 5 since the translated digital data record 4 is provided in machine language readable by the manufacturing facility without requiring further adaptions.

Although only a few embodiments of the present invention have been shown and described, it is to be understood that many changes and modifications may be made thereunto without departing from the spirit and scope of the invention.

What is claimed is:

1. A computer-implemented method for automatically translating at least one pre-defined digital data record (3) representing a cutting line (1) for an orthodontic appliance (5), preferably in the form of an aligner, a retainer or a bracket, into at least one translated digital data record (4) readable by at least one manufacturing facility, preferably comprising a milling device and/or a laser device, the method comprising automatically transferring via an algorithm the at least one pre-defined digital data record (3) into at least one translated digital data record (4) representing at least one translated cutting line (2) such that the at least one manufacturing facility can directly cut the orthodontic appliance (5) along the translated cutting line (2).

2. The computer-implemented method according to claim 1, wherein the at least one pre-defined digital data record (3) and/or the at least one translated digital data record (4) comprises a discrete set of, preferably spatially and/or equidistantly, separated points (6) along the cutting line (1) and/or the translated cutting line (2), wherein the at least one pre-defined digital data record (3) and/or the at least one translated digital data record (4) is in the form of a CSV file and/or a TXT file and/or an STL file and/or a CAD file and/or the at least one translated digital data record (4) represents a closed spline (7) around the orthodontic appliance (5) to be cut.

3. The computer-implemented method according to claim 1, wherein the at least one pre-defined digital data record (3)
is constructed manually or automatically by means of a CAD software, a CAM software and/or a treatment planning software and/or
comprises six coordinates (8) for each point (6) of the cutting line (1), wherein three coordinates (8) of the six coordinates (8) correspond to each point and three other coordinates (8) of the six coordinates (8) correspond to a normal vector and/or a unit vector for each point (6).

4. The computer-implemented method according to claim 1, wherein the at least one translated digital data record (4) comprises three coordinates (8) and at least two angles (9) for each point (6) of the translated cutting line (2) for a cutting device (10) of the at least one manufacturing facility.

5. The computer-implemented method according to claim 1, wherein the at least one translated digital data record (4) is created for a specific cutting device (10), preferably a milling tool and/or laser, of the at least one manufacturing facility.

6. The computer-implemented method according to claim 4, wherein the at least one translated digital data record (4) comprises, preferably for each point (6) and/or between two adjacent points (6) along the translated cutting line (2), a translation and/or a rotation of the coordinates (8) of the at least one pre-defined digital data record (3).

7. The computer-implemented method according to claim 1, wherein at least one configuration file (11) is created and/or used to create the at least one translated digital data record (4) for a specific cutting device (10), preferred milling tool and or laser, of the at least one manufacturing facility, wherein the at least one configuration file (11) comprises at least one of the following parameters (22) of and/or for the at least one manufacturing facility, preferably for each point (6) and/or between two adjacent points (6) along the translated cutting line (2): a velocity for the cutting device (10), a penetration depth for the cutting device (10), a half of an lateral extension of the cutting device (10), a length of the cutting device (10), a longitudinal extension of the milling tool, a laser intensity, a smoothening degree, a number of iteration steps, a minimal declination angle to a basic level (12).

8. The computer-implemented method according to claim 7, wherein the algorithm accesses the configuration file (11) and the at least one pre-defined digital data record (3), preferably all pre-defined digital data records (3) within a specific folder, for creation of the at least one translated digital data record (4), preferably of a plurality of translated digital data records (4).

9. The computer-implemented method according to claim 1, wherein the algorithm comprises an artificial intelligence, preferably comprising neuronal networks, machine learning and/or deep-learning, to create the at least one translated digital data record (4).

10. The computer-implemented method according to claim 1, wherein the translated cutting line (2) of the at least one translated digital data record (4) is smoothened with respect to the cutting line (1) of the at least one pre-defined digital data record (3), wherein it is preferred that the at least one translated digital data record (4) comprises supplementary points (13) along the translated cutting line (2).

11. A computer program which, when the program is executed by a computer (14) causes the computer (14) to carry out the computer-implemented method according to claim 1.

12. A system for creating a translated cutting line (2) for an orthodontic appliance (5), which is preferably in the form of an aligner, a retainer or a bracket, comprising at least one computing device (15), at least one memory device (16) which is configured to be accessed by the at least one computing device (15), at least one first interface (17) configured for receiving at least one pre-defined digital data record (3) representing a cutting line (1) for the orthodontic appliance (5) and/or for storing at least one pre-defined digital data record (3) and/or at least one translated digital data record (4) representing the translated cutting line (2) for the orthodontic appliance (5) in the at least one memory device (16) and at least one second interface (18) configured for outputting the at least one translated digital data record (4), wherein the at least one computing device (15) is configured to transfer the at least one pre-defined digital data record (3) into the at least one translated digital data record (4) such that at least one manufacturing facility can read the at least one translated digital data record (4) and directly cut the orthodontic appliance (5) along the translated cutting line (2).

13. The system according to claim 12, wherein the system comprises
a manufacturing facility, preferably in the form of a cutting device (10) comprising a milling tool or a laser, for manufacturing the orthodontic appliance (5) and/or
a construction facility in the form of a client, preferably in the form of a CAD client, a CAM client and/or a treatment planning software, for constructing a three-dimensional virtual model (19) representing at least part of a dentition (20) of a patient and/or the orthodontic appliance (5), whereby the client is configured to automatically construct the cutting line (1) based on the three-dimensional virtual model (19) and/or the translated cutting line (2) based on the least one pre-defined digital data record (3),
wherein it is preferred that the manufacturing facility and the construction facility are in signal-conducting data connection.

14. A method for manufacturing an orthodontic appliance (5), preferably in the form of an aligner, a retainer or a bracket, comprising the following steps:
inputting at least one a pre-defined digital data record (3) representing a cutting line (1) for the orthodontic appliance (5)
transferring the at least one pre-defined digital data record (3) into at least one translated digital data record (4) representing a translated cutting line (2) for the orthodontic appliance (5) readable by at least one manufacturing facility
manufacturing the orthodontic appliance (5)
cutting the orthodontic appliance (5) by means of the manufacturing facility, preferred milling device and/or laser device, along the translated cutting line (2)
if applicable, iterating the process step of manufacturing and cutting for a plurality of treatment steps based on a plurality of translated digital data records (4).

15. The method according to claim 14, wherein a mold (21) is manufactured by means of a three-dimensional virtual model (19) representing at least part of a dentition (20) of a patient of a construction facility in the form of a client, preferred in the form of a CAD client, a CAM client and/or a treatment planning software, wherein the orthodontic appliance (5) to be manufactured is in the form of an aligner which is formed over the mold (21).
